(19) United States
(12) Patent Application Publication
(10) Pub. No.: US 2008/0003401 A1
(43) Pub. Date: Jan. 3, 2008

(54) METALLIC MINI HOOKS FOR JOINING OF METALLIC AND COMPOSITES

(75) Inventors: John E. Barnes, Roswell, GA (US); Robert W. Koon, Acworth, GA (US); Robert J. Olliffe, Roswell, GA (US); Stephen P. Engelstad, Marrietta, GA (US)

Correspondence Address: ROBERT A. McLAUCHLAN, P.O. BOX 26780, AUSTIN, TX, 78755, US

(73) Assignee: Lockheed martin Corporation

(21) Appl. No.: 11/426,937

(22) Filed: Jun. 28, 2006

(51) Int. Cl. B32B 3/06

(52) U.S. Cl. 428/99

(57) ABSTRACT

A method for joining a first structural member and a metallic substrate is provided. This method involves drawing projections from a metallic substrate using a Co-Meld or other like process. Individual plies of composite materials may be laid upon the metallic substrate and projections. These projections penetrate the individual ply or layers of the composite material. A mechanical feature that serves as a retaining device may be located at the distal end of the projections in order to prevent separation of the composite materials from the metallic substrate. The composite materials may be infused with a resin or other material to complete the formation of the composite material. Additionally, other layers of composite material may be placed over the mechanical features located at the distal ends.

### TECHNICAL FIELD OF THE INVENTION

The present invention relates generally to structural joints and more particularly a method to join two or more members.

### BACKGROUND OF THE INVENTION

Structural joints in aircraft applications frequently involve the joining of metallic and composite structures. These joints are accomplished using typical fastening concepts which suffer from significant strength reductions caused by the need to drill holes in the metallic member. This joining method also requires significant setup time in drilling holes and installing fasteners to attach the members to one another. Such holes often produce localized stresses and mechanical loads that the structure must account for. To account for such localized loads, the structures are typically reinforced resulting in increased weight and loads to be handled by the structure. Furthermore, quality assurance issues may arise when installing such fasteners (misdrilled holes and improper fastener installation is common).

Friction Stir Welding (FSW) is a newer joining method, as illustrated in FIG. 1 which has gained acceptance as a means for joining

Further limitations and disadvantages of conventional and traditional joining process and related structures and functionality will become apparent to one of ordinary skill in the art through comparison with the present invention described herein.

### SUMMARY OF THE INVENTION

The present invention provides a means of joining a first structural member and a second structural member that substantially addresses the above identified needs as well as others.

Embodiments of the present invention provide a method for joining a first composite structural member and a metallic substrate is provided. This method involves drawing projections from a metallic substrate using a Co-Meld or other like process. Individual plies of composite materials are laid upon the metallic substrate and projections. These projections penetrate the individual ply or layers of the composite material. A mechanical feature that serves as a retaining device may be located at the distal end of the projections in order to prevent separation, or pull out failure, of the composite materials from the metallic substrate. During formation, the composite materials may be pre-impregnated with resin or in the form of a dry fabric which is later infused with a resin or other material to complete the formation of the composite material. Additionally, other layers of composite material may be placed over the mechanical features located at the distal ends.

In this way, the sheer strength of the bond between the composite material and the metallic substrate is greatly enhanced or reinforced through the use of projections which are typically oriented normally to the metallic substrate surface. This allows a three dimensional joint between the metallic substrate and the composite material to be formed as opposed to a traditional two dimensional interface. This strength benefit is inherit in the co-meld reinforcement technology.

The embodiment of the present invention provides a structural member that includes a metallic substrate on which a composite material is fastened. As with co-meld, this metallic substrate has a number of projections substantially oriented normal to the surface of the metallic substrate. These projections penetrate the individual layers of the composite material laid up on the metallic substrate. To further enhance the mechanical bond between the metallic substrate and the composite material, a retaining device such as a cap or deformation located at the distal end of the projection. This may be an end cap or button, hook, or other like deformation of the projection. This projection serves to retain the composite material at the proximate to the metallic substrate.

Embodiments of the present invention provide several distinctive advantages. First, the tooling associated with drilling holes and installing fasteners to secure composites and metallics is greatly reduced. Additionally, non-conformances may also be reduced as the composite material is laid up on the metallic substrate. Improvements in pull off strength as compared to traditionally bonded joints and standard Co-Meld joints is observed as the composite is held by retaining mechanical feature to the metallic substrate. Improved performance of the joint is realized without many of the drawbacks associated with traditional fasteners. For example, no drilling of the metallic substrate is required, part count is reduced, and a fully flush outer mold line may result.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIGS. 1A through 1C provide a series of cross sectional drawings that illustrate shaped fasteners that may be used to mechanically secure a first structural member and a second structural member in accordance with an embodiment of the present invention;

FIGS. 2A through 2D provide a series of cross sectional drawings that illustrate shaped fasteners that may be used to mechanically secure a first structural member and a second structural member in accordance with an embodiment of the present invention;

FIG. 3 provides an isometric view of two members such as composite layer and metallic substrate that have bonded using a capped or deformed projection in accordance with an embodiment of the present invention;

FIGS. 4A and 4F again shows a composite layer mechanically secured to a metallic substrate using deformed or capped projections in accordance with an embodiment of the present invention;

FIGS. 5A and 5B provide actual photographs of an array of a metallic substrate metallic substrate wherein an in-situ projection is built up from the substrate using a Co-Meld or other like process in accordance with an embodiment of the present invention; and

FIG. 6 provides a logic-flow diagram in accordance with an embodiment of the present invention that uses a deformed or capped projection to join a first member to a substrate.

### DETAILED DESCRIPTION OF THE INVENTION

Embodiments of the present invention are illustrated in the FIGUREs, like numerals being used to refer to like and corresponding parts of the various drawings.

Embodiments of the present invention provide a method for joining a composite structural member and a metallic substrate is provided. This method involves drawing projections from a metallic substrate using a Co-Meld or other like process. Individual plies of composite materials may be laid upon the metallic substrate and projections. These projections penetrate the individual ply or layers of the composite material. A mechanical feature that serves as a retaining device is located at the distal end of the projections in order to prevent separation, or pull out failure, of the composite materials from the metallic substrate. During fabrication, the composite materials may be pre-impregnated with resin or in the form of dry fabric which is later infused with a resin or other material to complete the formation of the composite material. Additionally, other layers of composite material may be placed over the mechanical features located at the distal ends.

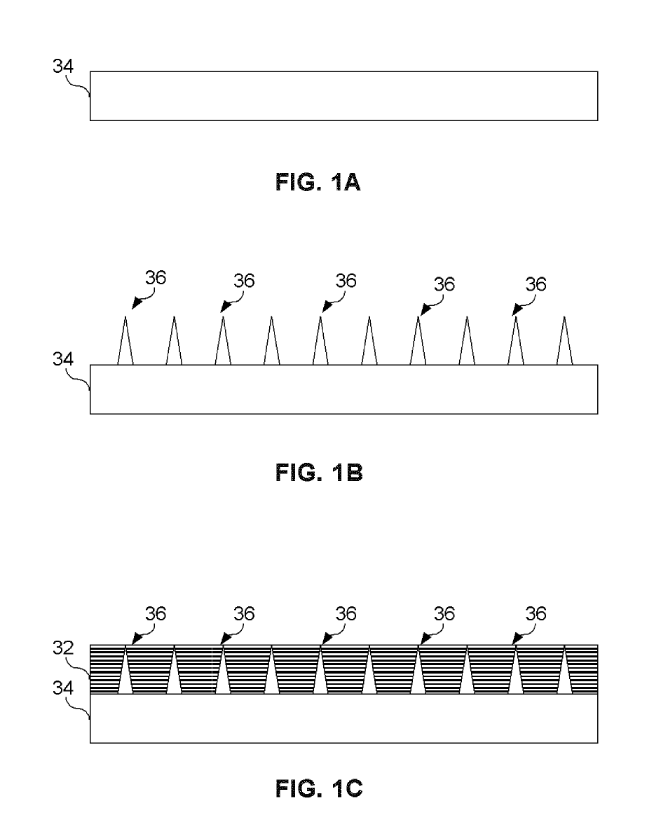

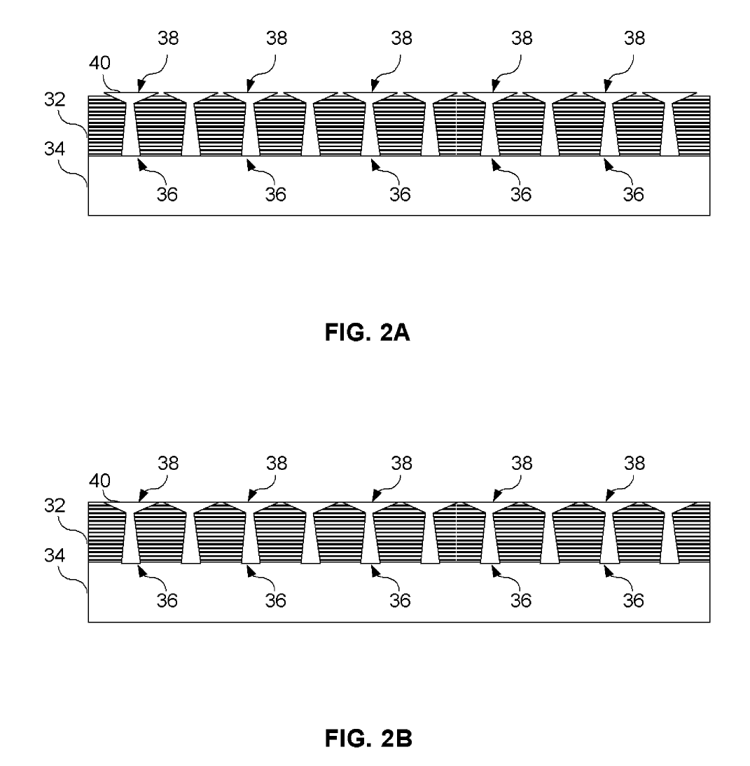

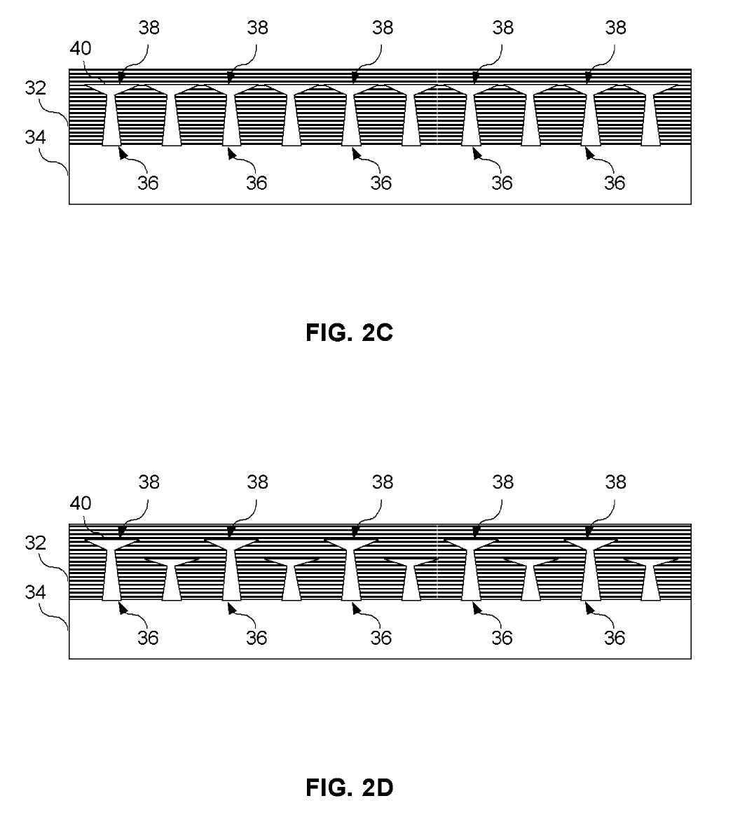

The shape of the capped of deformed fasteners (i.e. projections) helps secure the first structural member to the metallic substrate. FIGS. 1A through 1C and FIGS. 2A through 2D provide a series of cross sectional drawings that illustrate a method of forming an in-situ shaped fastener that may be used to mechanically join a first structural member and a second structural member. The process begins with a metallic substrate 34 as shown in FIG. 1A. In FIG. 11a Co-Meld process or other like process may be used to draw a number of Projections 36 from metallic substrate 34. In FIG. 1C a composite material 32 is shown as being laid up on the Metallic Substrate 34 in Projections 36. The Z axis penetration of the projections within the Composite Material 32 provide a more robust mechanical joint when compared to merely laying up a composite material on a metallic substrate with a sole horizontal interface between the upper surface for the metallic substrate 34 and the lower surface of the composite material 32. After the composite material 32 has been laid up on projections 36, the projections are deformed using an E-beam process or other mechanical or thermal process. The deformation 38 at the distal end 40 of projection 36 creates a mechanical feature such as a cap or other like mechanical feature that serves to retain or secure the composite material 32 to the metallic substrate 34.

Incorporation of this deformation or cap on the projection greatly enhances the pull off strength and/or shear strength associated with the interface between the composite material 32 and metallic substrate 34. FIG. 2A shows that the deformation of the projections 36 may be mechanically processed to ensure a flush continuous outer surface of composite material 32.

As shown in FIG. 2B additional composite material may be incorporated on the previous outer surface to again provide a flush outer surface for the mechanical joint. In FIG. 2D the projections and deformations or caps are staggered in height within the composite material laid up therein in order to again increase the pull off strength associated with the composite material to metallic substrate joint. By eliminating the drilling of metallic members on the aircraft quality issues associated with the assembly of composite materials and fastener location may be reduced as well.

This composite material may include metallic components woven into or within the composite matrix. These metallic components may improve the joint by bonding to the material deposited during the cold spraying process. The use of composite and metallic parts often requires complex solutions to join metallic and composite components. This typically involves drilling holes and installing fasteners to attach the dissimilar materials. The time associated with setup, tooling and accuracy associated with placing these fasteners may become large quality assurance issues as well as time consuming portions of the manufacturing process.

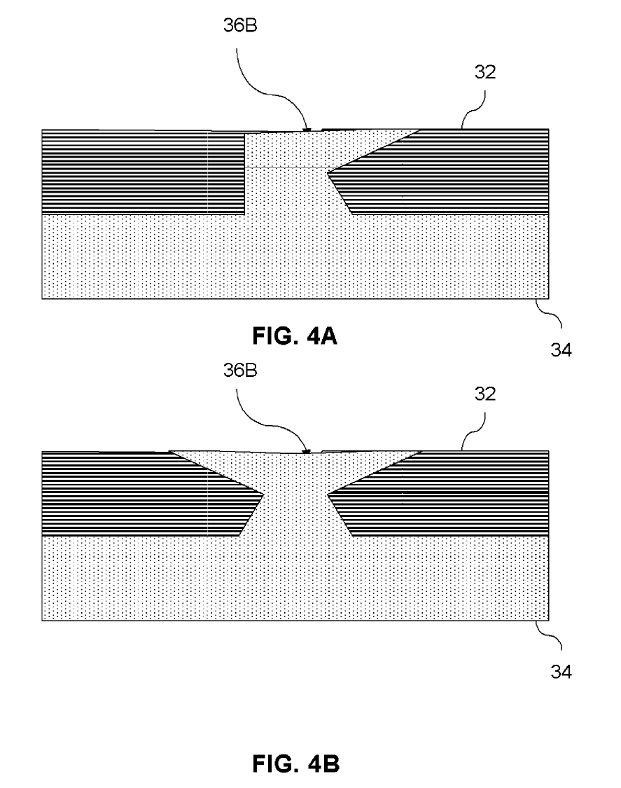

Substrates choice is limited by their ability to provide metallic material from which the projection is drawn. The site and material may be chosen in order to avoid weaknesses as seen at the base of the projections. Returning to the series of cross-sectional diagrams provided in FIGS. 1A through 2D. The projections 26 may be tapered as shown in FIGS. 4A and 4B. Steeper taper angles may result in increased mechanical properties of the deformed or capped projection to be formed during the Co-Meld process.

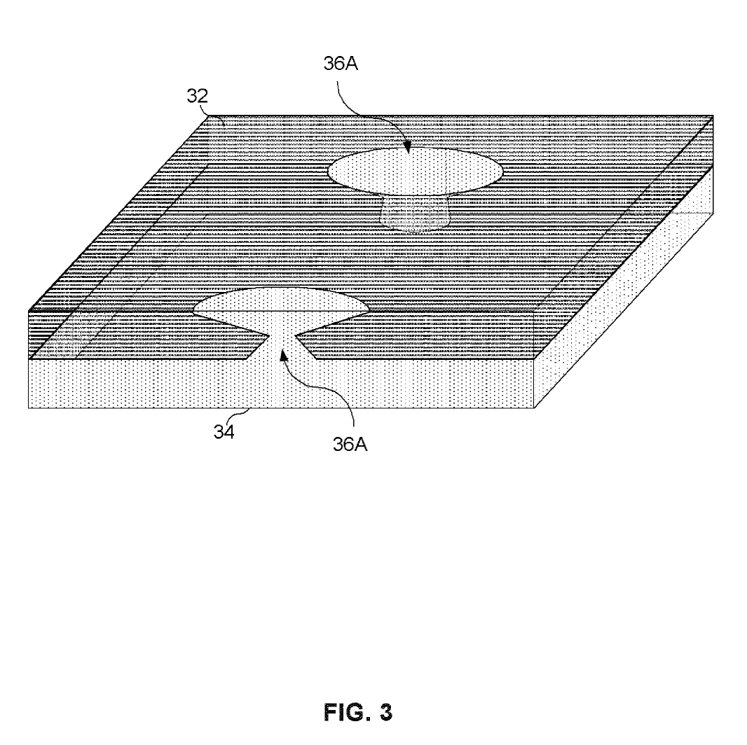

FIG. 3 provides an isometric view of two members such as composite layer 32 and metallic substrate 34 that have bonded using capped or deformed projections 36.

FIGS. 4A and 4B again shows a composite layer 32 mechanically secured to a metallic substrate 34 using deformed or capped projections. Additionally, a friction stir-well process may be applied to mix and further bond the materials drawn from the metallic substrate during the Co-Meld process. Deformed or capped projection 36B is shown within the composite material and again a friction stir-well process may be applied to this deformed or capped projection. In FIG. 4A the projection 36C may be bent, while the projection is capped in FIG. 4B

FIGS. 5A and 5D provide actual photographs of an array of a metallic substrate metallic substrate 84 wherein an in-situ projection 86 is built up from the substrate using a Co-Meld or other like process. More specifically FIG. 5A shows the metallic substrate 84 wherein non-tapered or deformed projections (fastener) 86 have been drawn from the surface of metallic substrate 84. The photograph provided in FIG. 5B shows that a cap or deformation 88 has been formed on the distal end of projections 86.

The upper surface of in-situ projection 86 may be milled after the composite has been laid up and infused to provide a flush or continuous surface of the composite material. This eliminates any portion of the deformed or capped projection that extends above the surface of composite layer.

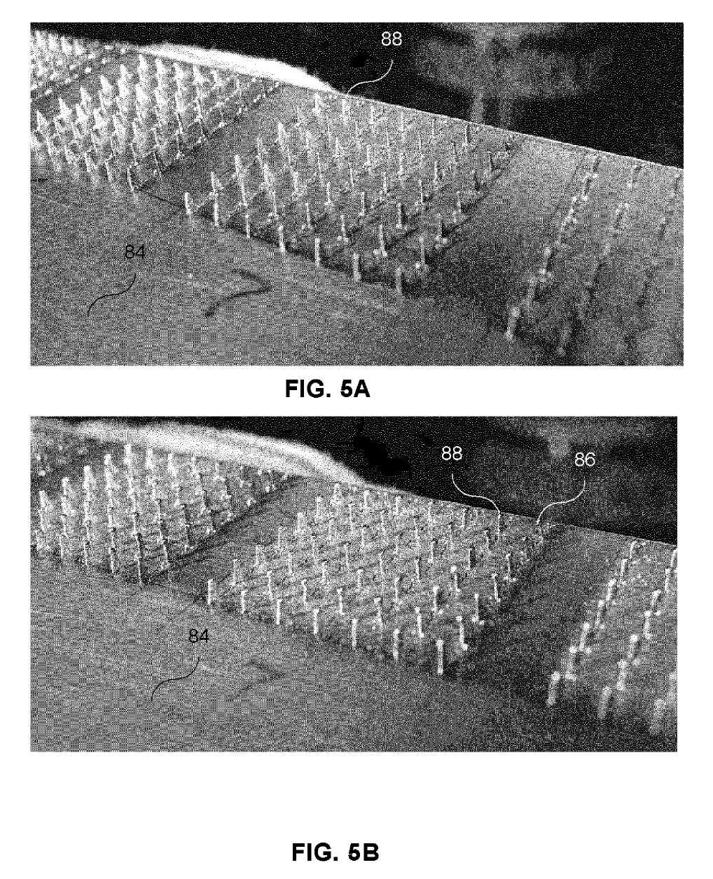

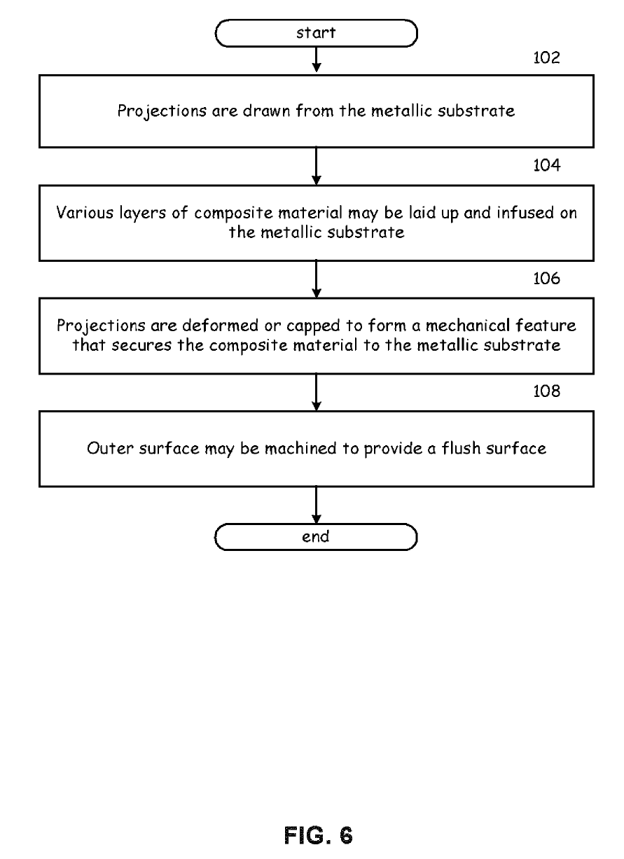

FIG. 6 provides a logic-flow diagram in accordance with an embodiment of the present invention that uses a deformed or capped projection to join a first member to a substrate. Process 100 begins in Step 102 where projections are drawn from the metallic substrate using a Co-Meld or other like process. In Step 104 various layers of composite material may be laid up on the metallic substrate. The projections penetrate the individual layers or plys of the composite material. This allows an in-situ fastener to be built up that secures the composite to the second structural member or metallic substrate. In Step 110 the upper surface of the deformed or capped projection may be milled in order to provide a smooth continuous upper surface of the joined materials.

Embodiments of the present invention provide in-situ fasteners which may be used to secure materials such as composite materials to metallic materials. This is achieved without the need drill into the metallic or composite materials. Such an arrangement reduces the setup costs in time and money that are associated with drilling holes, installing fasteners and addressing nonconformance. These setup costs have been determined to be the greatest assembly line cost driver for some advanced aircraft. Further, the issue of hole alignment to fasteners is essentially eliminated. Thus reducing the quality assurance issues associated with nonconformance. By preparing the composite materials off-line, edge distance concerns are greatly reduced.

In so doing, the fatigue lives of the joint between structural members are extended through the elimination of localized stresses concentrated by prior fasteners. Stiffness can be better distributed over the entire interface versus 2 or 3 holts/fasteners interfaces enabling lower overall weight of the structural members and structure. This reduces or eliminates complex tooling requirements. Pull off strength and fatigue life in the finished structure may be improved.

In summary, embodiments in the present invention provide a system and method of joining structural members. This method involves drawing projections from a metallic substrate using a Co-Meld or other like process. Individual plies of composite materials may be laid upon the metallic substrate and projections. These projections penetrate the individual ply or layers of the composite material. A mechanical feature that serves as a retaining device is located at the distal end of the projections in order to prevent separation of the composite materials from the metallic substrate. In cases where the laid up composite is in the form of a fabric perform, the composite materials may be infused with a resin or other material to complete the formation of the composite material. Additionally, other layers of composite material may be placed over the mechanical features located at the distal ends.

Although the present invention is described in detail, it should be understood that various changes, substitutions and alterations can be made hereto without departing from the spirit and scope of the invention as described by the appended claims.

What is claimed is:

1. A method for joining a first structural member and a metallic substrate, comprising:
drawing at least one projection from a metallic substrate;
laying up composite materials on the metallic substrate;
infusing and bonding the composite materials in place; and
wherein a mechanical feature located at a distal end of the at least one projection prevents separation of the composite materials from the metallic substrate.

2. The method of claim 1, further comprising deforming the distal end of the at least one projection to form the mechanical feature.

3. The method of claim 2, wherein the at least one projection is capped or deformed mechanically, thermally or using an e-beam.

4. The method of claim 1, wherein Co-Meld processing is used to form the at least one projection.

5. The method of claim 1, wherein additional composite material is laid up over the mechanical feature.

6. The method of claim 1, Co-Meld processing is used to form the at least one projection.

7. The method of claim 1, wherein the first structural member presents a flush outer surface.

8. The method of claim 1, wherein the metallic substrate comprises an aluminum alloy.

9. The method of claim 1, wherein the metallic substrate comprises titanium or a titanium alloy.

10. A fastener to join a composite material and a metallic substrate, comprising:
at least one projection drawn from a metallic substrate, wherein the at least one projection penetrates a composite material laid up on the metallic substrate, and wherein a mechanical feature located at a distal end of the at least one projection prevents separation of the composite materials from the metallic substrate.

11. The fastener of claim 10, wherein the distal end of the at least one projection is deformed to form the mechanical feature.

12. The fastener of claim 11, wherein the at least one projection is capped or deformed mechanically, thermally or using an e-beam.

13. The fastener of claim 10, wherein Co-Meld processing is used to form the at least one projection.

14. The fastener of claim 10, wherein additional composite material is laid up over the mechanical feature.

15. The fastener of claim 10, wherein the metallic substrate comprises an aluminum alloy.

16. The fastener of claim 10, wherein the metallic substrate comprises titanium or a titanium alloy.

17. A mechanical joint to secure a composite material and a metallic substrate, comprising:
a metallic substrate;
a composite material laid up on the metallic substrate; and
at least one projection drawn from the metallic substrate, wherein the at least one projection penetrates the composite material, and wherein a mechanical feature located at a distal end of the at least one projection prevents separation of the composite materials from the metallic substrate.

18. The mechanical joint of claim 17, wherein the distal end of the at least one projection is deformed or capped to form the mechanical feature.

19. The mechanical joint of claim 17, wherein the at least one projection is capped or deformed mechanically, thermally or using an e-beam.

20. The mechanical joint of claim 17, wherein Co-Meld processing is used to form the at least one projection.

21. The mechanical joint of claim 17, wherein additional composite material is laid up over the mechanical feature.

22. The mechanical joint of claim 17, wherein the metallic substrate comprises aluminum or an aluminum alloy.

23. The mechanical joint of claim 17, wherein the metallic substrate comprises titanium or a titanium alloy.
